(19) United States
(12) Patent Application Publication
(10) Pub. No.: US 2026/0066513 A1
(43) Pub. Date: Mar. 5, 2026

(54) ADJUSTABLE GAIN SLOPE COMPENSATOR

(71) Applicant: Qorvo US, Inc., Greensboro, NC (US)

(72) Inventors: Douglas Johnson, Doylestown, PA (US); Kelly M. Lear, Longwood, FL (US)

(21) Appl. No.: 19/237,186

(22) Filed: Jun. 13, 2025

Related U.S. Application Data
(60) Provisional application No. 63/688,023, filed on Aug. 28, 2024.
(60) Provisional application No. 63/734,349, filed on Dec. 16, 2024.

(51) Int. Cl. H01P 1/10; H01P 1/22; H04B 1/401; H04B 1/405

(52) U.S. Cl. CPC H01P 1/10; H01P 1/22; H04B 1/401; H04B 1/405

(57) ABSTRACT

Adjustable gain slope compensators and methods for use are disclosed. In one aspect, a compensator with multiple switchably engaged stages may be positioned in a signal path. The stages are selectively switched in or out of the signal path to achieve a desired gain slope compensation to offset overamplification in the signal path. In further aspects, the compensator is able to be adjusted dynamically. In further aspects, the stages may be bypassed completely so as to avoid adding unwanted attenuation to the signal path. The ability to control the compensator digitally allows greater control to provide specific slope values while providing improved return loss and improved bandwidth characteristics.

### PRIORITY APPLICATIONS

The present application claims priority to U.S. Provisional Patent Application Ser. No. 63/688,023, filed on Aug. 28, 2024, and entitled “DIGITALLY CONTROLLED MULTI-SECTION GAIN SLOPE COMPENSATOR,” the disclosure of which is incorporated herein by reference in its entirety.

The present application claims priority to U.S. Provisional Patent Application Ser. No. 63/734,349, filed Dec. 16, 2024, and entitled “ADJUSTABLE GAIN SLOPE COMPENSATOR,” which is incorporated herein by reference in its entirety

### BACKGROUND

### I. Field of the Disclosure

The technology of the disclosure relates generally to gain slope compensation.

### II. Background

Communication devices abound in modern society. These devices come in a variety of formats and use a variety of communication standards. While both wireless and wire-based communication devices exist, of interest are wire-based communication networks, such as cable networks that provide cable television and/or internet access with the understanding that the internet access may provide voice over internet protocol (VOIP) telephony and/or video streaming services. In some cases, these wire-based networks stretch over multiple miles. Accordingly, it is common in such networks to have periodic repeaters, which include amplifiers to boost the signals transmitted therethrough to sufficient levels to reach the next repeater. Such amplification is typically chosen at levels that assume worst-case topologies (e.g., maximal distance between repeaters). This may occasionally result in overamplification of the signals for destinations that are less than maximally distant from the repeater. Offsetting this overamplification provides room for innovation, not just in cable networks but in any network that has these sorts of amplification schemes.

### SUMMARY

Aspects disclosed in the detailed description include adjustable gain slope compensators and methods for use. In particular, a compensator with multiple switchably engaged stages may be positioned in a signal path. The stages are selectively switched in or out of the signal path to achieve a desired gain slope compensation to offset overamplification in the signal path. In further aspects, the compensator is able to be adjusted dynamically. In further aspects, the stages may be bypassed completely so as to avoid adding unwanted attenuation to the signal path. The ability to control the compensator digitally allows greater control to provide specific slope values while providing improved return loss and improved bandwidth characteristics.

In this regard, in one aspect, a tilt compensator is disclosed. The tilt compensator includes a first stage comprising a first switch, a bypass path, a tilt circuit, and a second switch, wherein the first switch and the second switch are configured to route signals through the tilt circuit in a first mode and bypass the tilt circuit using the bypass path in a second mode. The tilt compensator also includes a second stage comprising a second first switch coupled to the second switch of the first stage, a second bypass path, a second tilt circuit, and a second second switch, wherein the second first switch and the second second switch are configured to route signals through the second tilt circuit in a third mode and bypass the second tilt circuit using the second bypass path in a fourth mode. The tilt compensator further includes a control circuit configured to select between the first mode and the second mode for the first stage and the third mode and the fourth mode for the second stage to achieve a predetermined combined tilt adjustment on the signals.

In another aspect, a repeater is disclosed. The repeater includes an input and a tilt compensator comprising a first stage comprising a first switch, a bypass path, a first tilt circuit, and a second switch, wherein the first switch and the second switch are configured to route signals through the tilt circuit in a first mode and bypass the tilt circuit using the bypass path in a second mode. The repeater also includes a second stage comprising a second first switch coupled to the second switch of the first stage, a second bypass path, a second tilt circuit; and a second second switch, wherein the second first switch and the second second switch are configured to route signals through the second tilt circuit in a third mode and bypass the second tilt circuit using the second bypass path in a fourth mode. The repeater also includes a control circuit configured to select between the first mode and the second mode for the first stage and the third mode and the fourth mode for the second stage to achieve a predetermined combined tilt adjustment on the signals, an amplifier coupled to the tilt compensator, and an output coupled to the amplifier.

In another aspect, a method is disclosed. The method includes receiving a signal at a repeater and switching on and off tilt circuits to provide a tilt compensation for the signal.

### BRIEF DESCRIPTION OF THE DRAWINGS

FIG. 1 is a schematic of a wire-based communication network with repeaters that may be used with the present disclosure;

FIG. 2 is a block diagram of a repeater according to the present disclosure;

FIG. 3 is a block diagram of an exemplary compensator according to present disclosure;

FIG. 4 is a block diagram of an alternate exemplary compensator according to the present disclosure;

FIG. 5A is a block diagram of a T-network tilt stage that may be used in the compensators of the present disclosure;

FIG. 5B is a block diagram of a Pi-network tilt stage that may be used in the compensators of the present disclosure;

FIG. 5C is an exemplary specific T-network; and

FIG. 6 is a flowchart illustrating an exemplary process for controlling the adjustable gain slope compensator of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that although the terms first, second, etc. may be used herein to describe various elements, these elements should not be limited by these terms. These terms are only used to distinguish one element from another. For example, a first element could be termed a second element, and similarly, a second element could be termed a first element without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element, or intervening elements may also be present. In contrast, when an element is referred to as being “directly on” or extending “directly onto” another element, no intervening elements are present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, no intervening elements are present. It will also be understood that when an element is referred to as being “connected” or “coupled” to another element, it can be directly connected or coupled to the other element, or intervening elements may be present. In contrast, when an element is referred to as being “directly connected” or “directly coupled” to another element, no intervening elements are present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In keeping with the above admonition about definitions, the present disclosure uses transceiver in a broad manner. Current industry literature uses “transceiver” in two ways. The first way uses transceiver broadly to refer to a plurality of circuits that send and receive signals. Exemplary circuits may include a baseband processor, an up/down conversion circuit, filters, amplifiers, couplers, and the like coupled to one or more antennas. A second way, used by some authors in the industry literature, refers to a circuit positioned between a baseband processor and a power amplifier circuit as a transceiver. This intermediate circuit may include the up/down conversion circuits, mixers, oscillators, filters, and the like, but generally does not include the power amplifiers. As used herein, the term transceiver is used in the first sense. Where relevant to distinguish between the two definitions, the terms “transceiver chain” and “transceiver circuit” are used respectively.

Additionally, to the extent that the term “approximately” is used in the claims, it is herein defined to be within ten percent (10%).

Aspects disclosed in the detailed description include adjustable gain slope compensators and methods for use. In particular, a compensator with multiple switchably engaged stages may be positioned in a signal path. The stages are selectively switched in or out of the signal path to achieve a desired gain slope compensation to offset overamplification in the signal path. In further aspects, the compensator is able to be adjusted dynamically. In further aspects, the stages may be bypassed completely so as to avoid adding unwanted attenuation to the signal path. The ability to control the compensator digitally allows greater control to provide specific slope values while providing improved return loss and improved bandwidth characteristics.

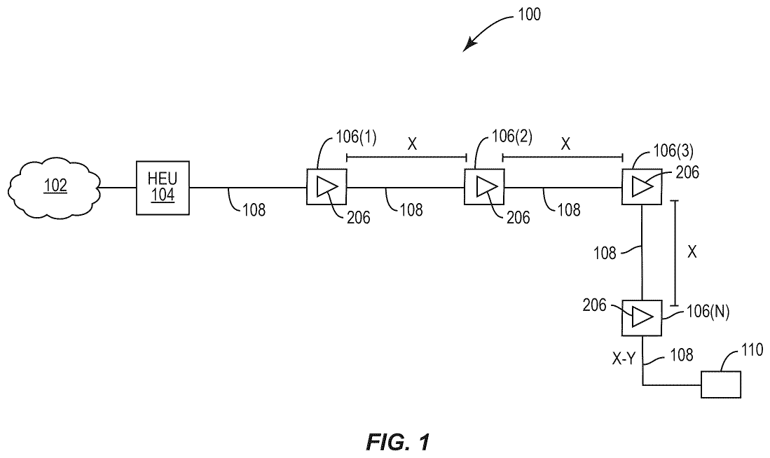

In this regard, FIG. 1 illustrates a wire-based communication network 100, which may, in an exemplary aspect, be a cable network. While the following discussion presumes a cable network environment, it should be appreciated that the present disclosure is not limited to such environments and can be used with any communication path that has the possibility of overamplification of signals that need to be offset. The communication network 100 may include or be coupled to a wider network 102 (e.g., the Internet, the public switched telephone network (PSTN), the public land mobile network (PLMN), or the like) from which signals flow to the communication network 100. The communication network 100 may include a head end unit (HEU) 104 that may act as a hub for signals passing through the communication network 100. While the present disclosure uses the term HEU, it should be appreciated that different networks may refer to similar elements with different terms, and no specific structure is to be implied by the use of HEU. The HEU 104 may include an upstream transceiver (not shown) that handles signals from the network 102 and a downstream transceiver (also not shown) that forwards signals into the rest of the communication network 100 as is well understood. There may additionally be a control circuit or intelligence that effectuates routing decisions and the like. These functions are conventional and not central to the present disclosure but are mentioned in the interests of completeness.

The HEU 104 may be coupled to repeaters 106(1)-106(N) through a communication medium 108 such as a coaxial cable or the like. While the repeaters 106(1)-106(N) are shown serially coupled, it should be appreciated that other topologies may be present (e.g., a daisy-chain, star, or some combination of various topologies) without departing from the present disclosure. Thus, while only one branch of repeaters 106(1)-106(N) is shown, it should be appreciated that the HEU 104 may be coupled to additional branches (i.e., in a star topology with each leg of the star being multiple serially coupled repeaters).

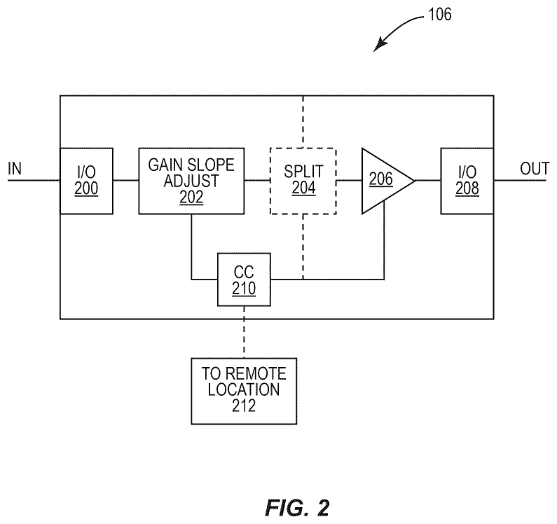

The communication medium 108 imposes some attenuation on signals passing therethrough. This attenuation is a function of frequency, material, cross-sectional area of the medium, skin effects of the medium and/or distance. During network planning, the designers may know that there is some total distance that must be covered by the communication medium. This total distance may be divided into planned distances “x. ” Thus, as shown, there is some distance “x” planned to be between each adjacent repeaters 106(1)-106(N) (e.g., repeater 106(1) and 106(2)). To compensate for the (sometimes frequency-dependent) attenuation of the distance x, an amplifier 206 discussed in greater detail below with reference to FIG. 2, may be provided to boost the signal, sometimes with the amount of boost varying with frequency. This frequency-dependent boost is typically referred to as a gain slope. When each repeater 106(1)-106(N) is separated by distance x, the attenuation is as planned, and little or no correction is required. However, if an endpoint 110, such as a building that has network service is not at distance x (i.e., x-some distance y), then the signal arrives at the endpoint 110 overamplified and/or oversloped. Note that this is also true between repeaters 106(1)-106(N) if adjacent repeaters 106(1)-106(N) are at less than the fully planned distance x.

Note that even in a well-designed system, process variations, temperature variations, and the like may also contribute to the signal arriving overamplified/oversloped. Still further, the planned amplification may be inconsistent over an operating frequency range, and some frequencies are overamplified so that the entire frequency band is sufficiently amplified (i.e., the system is designed for the worst-case frequency and thus overcompensates for other frequencies). Similarly, sometimes higher frequencies are more attenuated due to frequency-dependent losses. This situation is not strictly an overslope or underslope condition but is sometimes treated similarly, attenuating the lower frequencies by a similar amount to flatten the frequency response band.

FIG. 2 provides a block diagram of an exemplary repeater 106 that may be used in the communication network 100. The repeater 106 includes an input/output connector 200 that receives an upstream signal (e.g., from the HEU 104 or an upstream repeater 106(1)-106(N)). The I/O connector 200 is coupled to a gain slope adjust circuit or compensator 202 according to the present disclosure and described in greater detail below. The gain slope compensator 202 adjusts the slope or tilt of the signal and passes the signal forward. An optional splitter 204 may split the signal and route the signal in desired directions. Signals are then passed to an amplifier 206 that boosts the signal and passes the boosted signal to an I/O connector 208 for transmission to a downstream location (e.g., another repeater 106(1)-106(N) or an endpoint 110). A control circuit 210 may control one or more elements within the repeater 106 and may also be communicatively coupled to a remote location 212. In some exemplary aspects, the control circuit 210 may be omitted. While shown as being outside the primary signal path, the remote location 212 may communicate with commands embedded in signals on the primary path (e.g., the remote location may be in the HEU 104).

Historically, repeaters would use a fixed gain slope compensation network, which uses a fixed compensating gain slope to correct an existing undesirable, opposite gain slope. Because of the fixed nature of the compensation network, such networks would be manually changed to fix different slopes. Other analog approaches do exist and include combining the response of a variable attenuator (analog or digital) from a lower Q/wider band filter, usually with some for 180-degree hybrid/rat race or balun, to form a desired slope over a required frequency range. Such analog approaches usually result in high reflection losses over the bandwidth of interest.

Exemplary aspects of the present disclosure provide a network of at least two tilt circuits that may be switchably added to the signal path. The selective use of the different tilt circuits allows different net gain slopes to provide a desired overall gain slope adjustment (and/or provide flattened frequency responses to address frequency-dependent attenuation, which is considered to be within the definition of a tilt adjustment). The individual tilt circuits may be binary weighted, thermometer encoded, or some combination of binary and thermometer encoded. Two tilt circuits being the minimum necessary to provide desired flexibility, other numbers are also contemplated. For example, four or six tilt circuits provide a wide array of permutations and combinations. Other values (e.g., 3,5, 7+) are also possible and within the scope of the present disclosure.

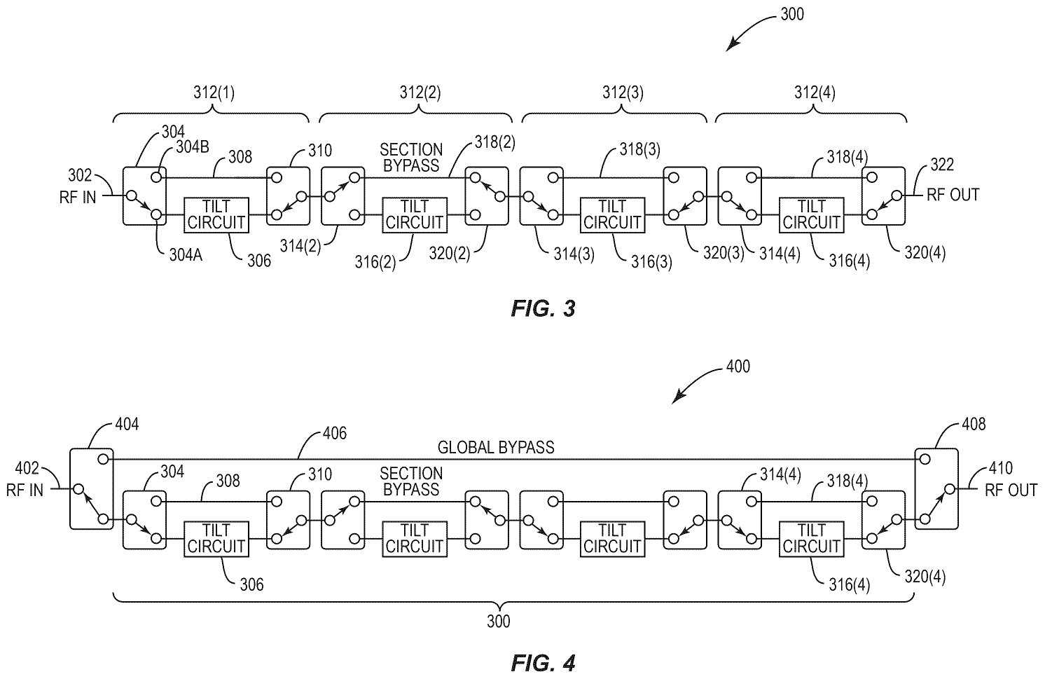

In this regard, FIG. 3 illustrates a first exemplary gain slope compensator 300 (which may be used as the gain slope compensator 202 in the repeater 106(1)-106(N) of FIG. 2). The gain slope compensator 300 has an input 302 that is coupled to a first switch 304. In an exemplary aspect, the first switch 304 is a single pole-dual throw (SPDT) switch. In a first position 304A (as shown) the first switch 304 couples the input 302 a first tilt circuit 306. In a second position 304B, the first switch 304 couples the input 302 to a first bypass line 308. The first tilt circuit 306 and the first bypass line 308 also couple to a second switch 310, which is also an SPDT switch. Collectively, the first switch 304, the first tilt circuit 306, the bypass line 308, and the second switch 310 form a stage 312(1). Additional stages 312(2)-312(4), each having a first switch 314(2)-314(4), a tilt circuit 316(2)-316(4), a bypass line 318(2)-318(4), and a second switch 320(2)-320(4) are serially positioned after the stage 312(1) with the second switch 310 being coupled to the first switch 314(2). The final stage 312(4) is coupled to an output 322. A control circuit such as the control circuit 210 may control the positions of the switches 304, 310, 314(2)-314(4), and 320(2)-320(4) to determine which tilt circuits 306, 316(2)-316(4) are used and which are bypassed. By using different combinations of tilt circuits 306, 316(2)-316(4), different net gain slope compensation may be provided.

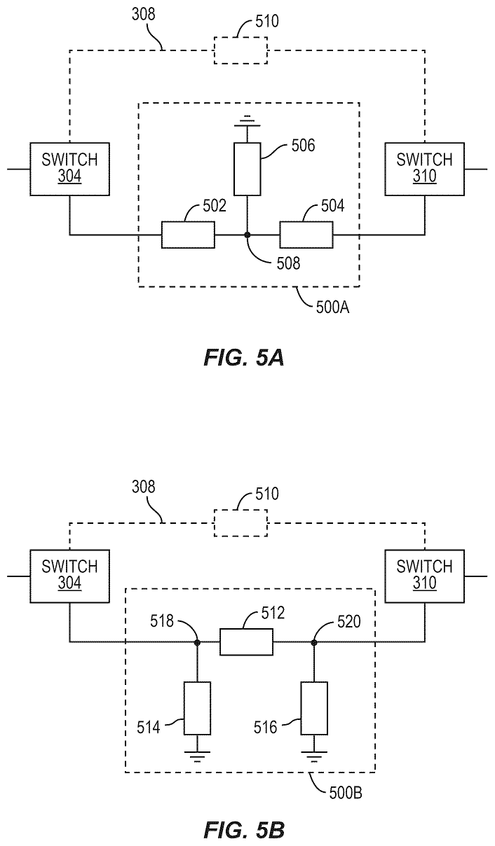

A second exemplary gain slope compensator 400 is illustrated in FIG. 4. The gain slope compensator 400 includes the compensator 300 but also has a global bypass option. Specifically, the gain slope compensator 400 includes an input 402 coupled to a first switch 404, which may be an SPDT switch coupled to the compensator 300 in a first position and a global bypass line 406 in a second position. The global bypass line 406 and the compensator 300 are coupled to a second switch 408, which may also be an SPDT switch. The second switch 408 is coupled to an output 410. Thus, the compensator 300 may be bypassed by the appropriate use of the switches 404, 408 or may be used as previously described.

By way of example, the tilt circuits 306, 316(2)-316(4) may be 1 dB, 2 dB, 4 dB and 8 dB, respectively; 2 dB, 4 dB, 8 dB, 16 dB, respectively; 1 dB, 2 dB, 4 dB, 4 dB respectively, or the like. Where more stages are supplied, more variation in the tilt compensation available is possible.

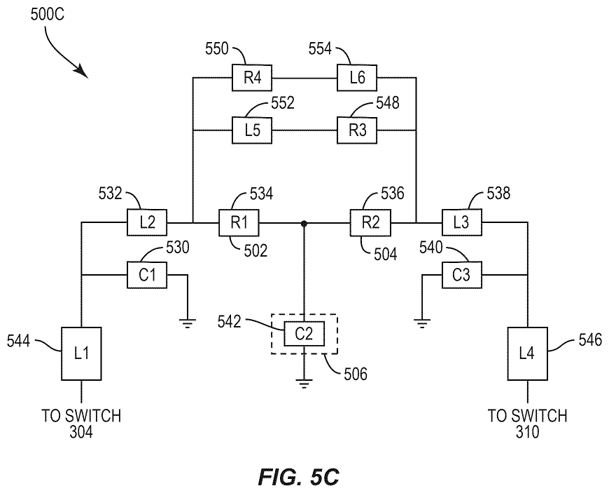

Exemplary tilt circuits 500A-500C are illustrated in FIGS. 5A-5C with the understanding that the tilt circuits 306, 316(2)-316(4) may correspond to any of the tilt circuits 500A-500C. Tilt circuit 500A may, for example, include three elements 502, 504, and 506 arranged in a T-network, with elements 502, 504 in series with a node 508 therebetween. The element 506 couples the node 508 to ground. While not shown in FIG. 5A, the T-network may be bridged by additional elements (e.g., one reactive and one resistive). Such bridging may include multiple bridges. It should be appreciated that the elements 502, 504, and 506 may be resistors, capacitors, inductors, or some combination of these components as better discussed below with reference to FIG. 5C. Further, the bypass line 308 may include at least one reactive element 510 to offset any capacitance of the switches. Note that not every switch will need matching, so the presence (or absence) of the at least one reactive element 510 is not central to the present disclosure.

Similarly, the tilt circuit 500B has three reactive elements 512, 514, and 516 arranged in a Π-network, with element 512 positioned between nodes 518 and 520. The elements 514 and 516 couple the nodes 518 and 520 to ground. Again, it should be appreciated that the elements 512, 514, and 516 may be resistors, capacitors, inductors, or some combination of these components. Again, bridging elements may be present.

By way of further illustration, FIG. 5C illustrates tilt circuit 500C with exemplary details of elements 502, 504, and 506 provided. That is, the element 502 is formed from a first resistor 534 with a matching circuit formed from a first capacitor 530 and a second inductor 532. The element 504 is formed from a second resistor 536 with a matching circuit formed from a third inductor 538 and a third capacitor 540. The element 506 is formed from a third capacitor 542. Additional first and fourth inductors 544, 546 couple the network to the switches 304, 310, respectively. As introduced in the discussion of FIG. 5A, the T-network of elements 502, 504, and 506 may be bridged by additional elements, and may have multiple bridges. Thus, FIG. 5C illustrates third and fourth resistors 548, 550 and fifth and sixth inductors 552, 554. As illustrated, each bridge includes (but is not required to contain) one resistive element and one reactive elements. That is, in an exemplary aspect, the first bridge includes the fifth inductor 552 and the third resistor 548, and the second bridge includes the fourth resistor 550 and the sixth inductor 554. Without limitation, certain of the elements may also be considered matching elements (e.g., elements 530, 532, 538, 540, 542, 544, and 546 may be considered matching elements). Further, while the drawings suggest that the elements of FIG. 3 are individual elements, it should be appreciated that one or more of these elements may be formed from one or more inductors, capacitors, and/or resistors. It should also be appreciated that the values of these components and the precise arrangement may be optimized for particular frequency response and this structure is provided by way of example and not as a necessary structure. For example, more (or less) matching elements and/or bridging elements may be present.

Note that the (optional) control circuit 210 may be used to determine which tilt circuits are active and which are bypassed. This may be done at installation by offsetting empirically measured signal input, at the factory based on an expected deployment, or the like. Further, the control circuit 210 may communicate with a remote location 212, the remote location 212 may also dynamically adjust the compensation provided.

Note that the repeaters 106(1)-106(N) are generally described as being operational in a first direction (i.e., downstream), but in practice, communication may be two way and each repeater 106 may have a downstream path and an upstream path, where the upstream path is substantially the same as the downstream path, but passing signals towards the HEU 104.

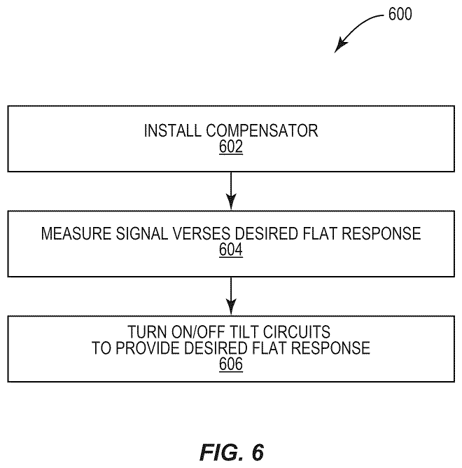

FIG. 6 provides a flow chart for a process 600 for deploying and using the compensator of the present disclosure. The process 600 begins by installing the compensator (block 602). The signal is measured and compared to a desired flat response (block 604). The control circuit 210 turns on/off tilt circuits 306, 316(2)-316(4) to provide a desired flat response (block 606).

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications, as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein but is to be accorded the widest scope consistent with the principles and novel features disclosed herein.

What is claimed is:

1. A tilt compensator comprising:
a first stage comprising:
a first switch;
a bypass path;
a tilt circuit; and
a second switch, wherein the first switch and the second switch are configured to route signals through the tilt circuit in a first mode and bypass the tilt circuit using the bypass path in a second mode;
a second stage comprising:
a second first switch coupled to the second switch of the first stage;
a second bypass path;
a second tilt circuit; and
a second second switch, wherein the second first switch and the second second switch are configured to route signals through the second tilt circuit in a third mode and bypass the second tilt circuit using the second bypass path in a fourth mode; and
a control circuit configured to select between the first mode and the second mode for the first stage and the third mode and the fourth mode for the second stage to achieve a predetermined combined tilt adjustment on the signals.

2. The tilt compensator of claim 1, further comprising a global bypass circuit configured to bypass the tilt circuit and the second tilt circuit.

3. The tilt compensator of claim 2, wherein the global bypass circuit comprises:
a global bypass path;
a global first switch coupled to the first switch and the global bypass path and configured to route signals to the first switch in an active mode and route signals to the global bypass path in a bypass mode; and
a global second switch coupled to the global bypass path and configured to receive signals therefrom in the bypass mode.

4. The tilt compensator of claim 1, wherein the first switch and the second switch comprise single pole dual throw switches.

5. The tilt compensator of claim 1, further comprising at least one additional stage coupled to the second stage and configured to provide switchable additional tilt compensation responsive to the control circuit.

6. The tilt compensator of claim 1, wherein the tilt circuit comprises a T-network of reactive elements.

7. The tilt compensator of claim 1, wherein the tilt circuit comprises a Π-network of reactive elements.

8. The tilt compensator of claim 1, wherein the bypass path comprises a reactive element configured to counteract capacitance of the bypass path.

9. The tilt compensator of claim 1, wherein the second tilt circuit has a second tilt compensation equal to a tilt compensation of the tilt circuit.

10. The tilt compensator of claim 1, wherein the second tilt circuit has a second tilt compensation greater than a tilt compensation of the tilt circuit.

11. The tilt compensator of claim 10, wherein the second tilt compensation is twice the tilt compensation.

12. A repeater comprising:
an input;
a tilt compensator comprising a first stage comprising:
a first switch;
a bypass path;
a tilt circuit; and
a second switch, wherein the first switch and the second switch are configured to route signals through the tilt circuit in a first mode and bypass the tilt circuit using the bypass path in a second mode;
a second stage comprising:
a second first switch coupled to the second switch of the first stage;
a second bypass path;
a second tilt circuit; and
a second second switch, wherein the second first switch and the second second switch are configured to route signals through the second tilt circuit in a third mode and bypass the second tilt circuit using the second bypass path in a fourth mode; and
a control circuit configured to select between the first mode and the second mode for the first stage and the third mode and the fourth mode for the second stage to achieve a predetermined combined tilt adjustment on the signals;
an amplifier coupled to the tilt compensator; and
an output coupled to the amplifier.

13. The repeater of claim 12, wherein the control circuit is also configured to control the amplifier.

14. The repeater of claim 12, further comprising an upstream path comprising an upstream tilt compensator and an upstream amplifier.

15. The repeater of claim 12, further comprising a global bypass circuit configured to bypass the tilt circuit and the second tilt circuit.

16. The repeater of claim 12 integrated into a coaxial cable network wherein the input comprises a coaxial cable connector.

17. A method comprising:
receiving a signal at a repeater; and
switching on and off tilt circuits to provide a tilt compensation for the signal.

18. The method of claim 17, further comprising determining the tilt compensation.

19. The method of claim 17, further comprising bypassing at least one tilt circuit.

20. The method of claim 17, further comprising bypassing all tilt circuits for at least one signal.

21. The method of claim 17, further comprising using the tilt compensation to provide a flattened frequency response band to compensate for frequency-based attenuation.
